(19) United States
(12) Patent Application Publication
(10) Pub. No.: US 2016/0119712 A1
(43) Pub. Date: Apr. 28, 2016

(54) SYSTEM AND METHOD FOR IN CABIN COMMUNICATION

(71) Applicant: GM GLOBAL TECHNOLOGY OPERATIONS LLC, Detroit, MI (US)

(72) Inventors: ELI TZIRKEL-HANCOCK, RA'ANANA (IL); MD-FOEZUR RAHMAN CHOWDHURY, TROY, MI (US); BASSAM S. SHAHMURAD, CLINTON TOWNSHIP, MI (US); ILAN MALKA, TEL AVIV (IL)

(21) Appl. No.: 14/525,695

(22) Filed: Oct. 28, 2014

(51) Int. Cl. H04R 1/32; H04R 3/00

(52) U.S. Cl. CPC H04R 1/323; H04R 3/005; H04R 1/326

(57) ABSTRACT

A system and methods are disclosed for improving communication between occupants in a cabin of a vehicle. A source location of a speaking occupant and an output location of a loudspeaker is identified using a microphone array. A beam forming module directs a main beam at the source location and a null beam at the output location. An audible communication from the speaking occupant is received with the microphone array, filtered with a spatial filter based on the main beam and the null beam and broadcast over the loudspeaker.

### TECHNICAL FIELD

The technical field generally relates to vehicle communications, and more particularly relates to communication between occupants in a cabin of a vehicle.

### BACKGROUND

In vehicles, such as automobiles, occupants are often seated facing forward in one or more rows. For instance, a driver and passenger may be seated in a front row and additional occupants may be seated in a rear row. When the occupants in the vehicle try to talk with one another, rear row occupants often have a hard time hearing front row occupants talking as there is not a direct acoustic path between the forward facing front row occupants and the occupants in the rear row. Additional noise in the vehicle cabin from the environment or generated as the vehicle travels further makes is hard for rear row occupants to hear front row occupants talking As such, front row occupants may have to raise their voices or turn their head to talk with the occupants in the rear row.

Accordingly, it is desirable to provide a system and a method for in cabin communication that allows front row occupants and rear row occupants to more easily communicate with one another. In addition, it is desirable to enhance in cabin communications without degrading the speech quality. Other desirable features and characteristics of the present invention will become apparent from the subsequent detailed description and the appended claims, taken in conjunction with the accompanying drawings and the foregoing technical field and background.

### SUMMARY

In one embodiment, a method is provided for facilitating communication between occupants in a cabin of a vehicle. In accordance with the method a main beam directed at a source location is formed and a null beam directed at an output location is formed. An audible communication from the speaking occupant is received with the microphone array to generate a microphone signal. The microphone signal is spatially filtered based on the main beam and the null beam to generate a beam former output signal that is then broadcast over the loudspeaker.

In another embodiment, a system is provided for facilitating communication between occupants in a cabin of a vehicle. The system includes an electronic control unit having a processor module and a memory. A microphone array receives an audible communication from the speaking occupant and generates a microphone signal based on the audible communication. A loudspeaker, having an output location, broadcasts a beam former output signal. A beam forming module having a processor module and a memory forms a main beam directed at a source location and a null beam directed at the output location. A spatial filter based on the main beam and the null beam is applied to the microphone signal to generate the beam former output signal, which is then broadcast from the loudspeaker.

In another embodiment, a vehicle includes a cabin having a system for facilitating communication between occupants in the cabin. The system includes an electronic control unit having a processor module and a memory. A microphone array receives an audible communication from the speaking occupant and generates a microphone signal based on the audible communication. A loudspeaker, having an output location, broadcasts a beam former output signal. A beam forming module having a processor and a memory forms a main beam directed at a source location and a null beam directed at the output location. A spatial filter based on the main beam and the null beam is applied to the microphone signal to generate beam former output signal, which is then broadcast from the loudspeaker.

### DESCRIPTION OF THE DRAWINGS

The exemplary embodiments will hereinafter be described in conjunction with the following drawing figures, wherein like numerals denote like elements, and wherein:

FIG. 1 illustrates an acoustic path in a cabin of a vehicle according to various embodiments;

FIG. 2 illustrates the communication system in accordance with an exemplary embodiment;

FIG. 3 is a flow chart illustrating a method for communication with the system shown in FIG. 2;

FIG. 4 illustrates the communication in accordance with another exemplary embodiment; and

FIG. 5 is a flow chart illustrating a method for communication with the system shown in FIG. 4.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. It should be understood that throughout the drawings, corresponding reference numerals indicate like or corresponding parts and features. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

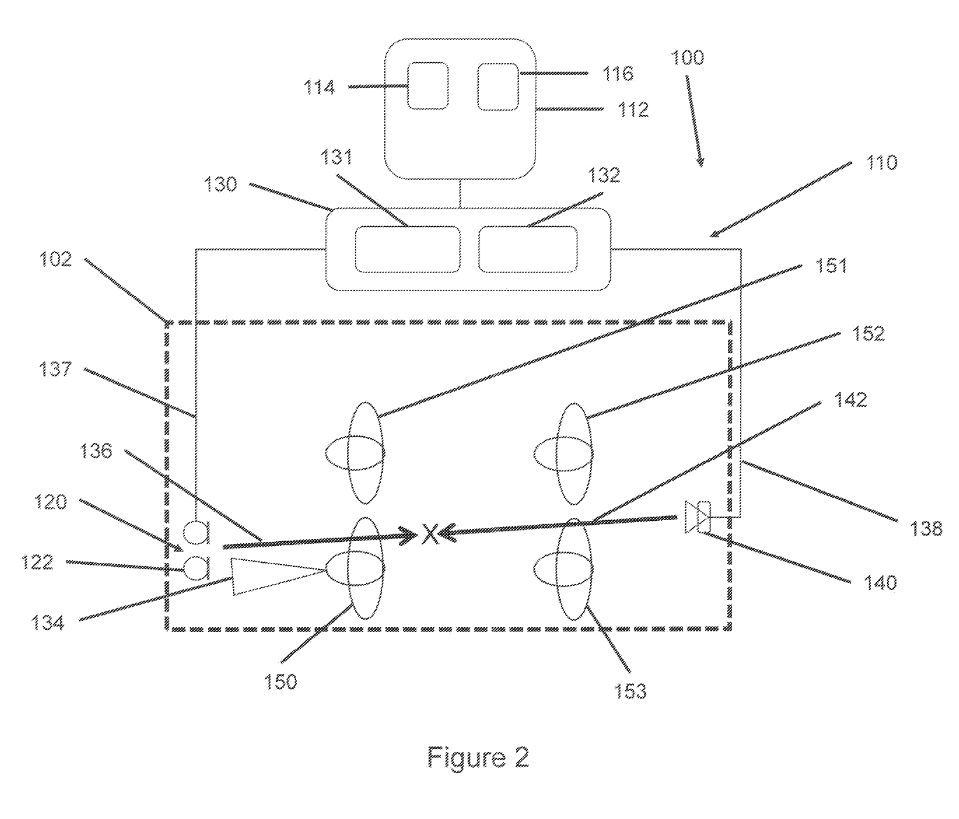

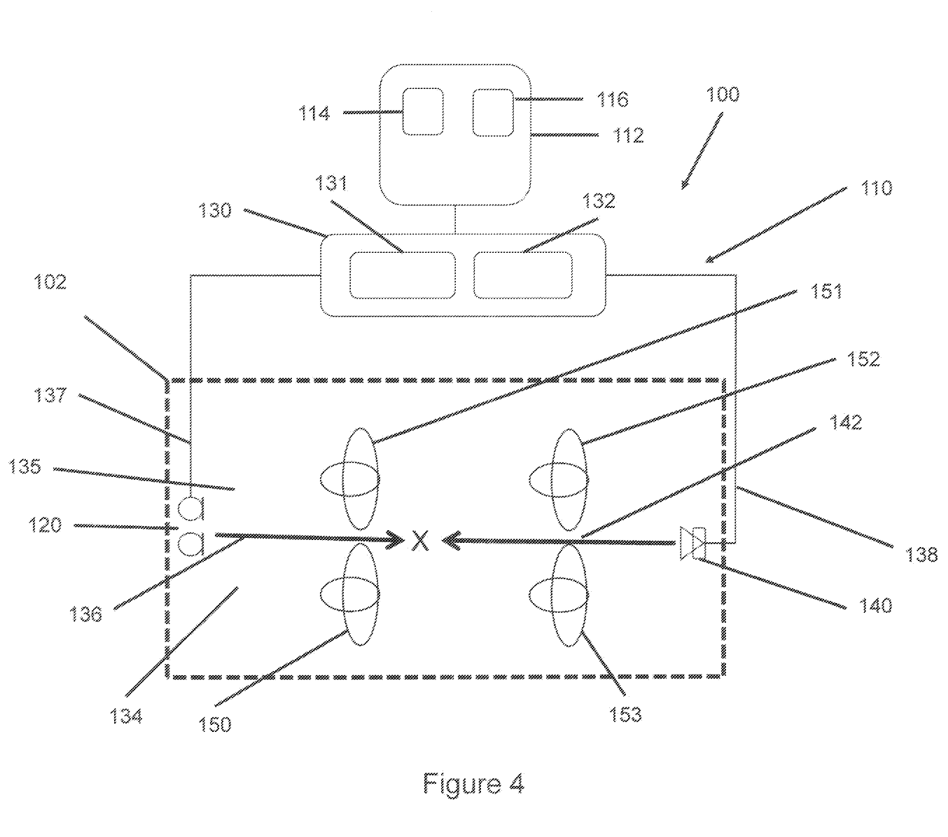

Referring to the figures, wherein like numerals indicate like parts throughout the several views, a vehicle 100 having a cabin 102 and a communication system 110 is shown herein. In the exemplary embodiments, the vehicle 100 is an automobile (not separately numbered). However, the communication system 110 may be implemented and/or utilized in other types of vehicles 100 or in non-vehicle applications. For instance, other vehicles 100 include, but are not limited to, aircraft, spacecraft, buses, trains, etc. As shown in FIGS. 2 and 4, the communication system 110 includes an electronic control unit 112 having a processor module 114 and a memory 116, a microphone array 120, a beam forming module 130, and a loudspeaker 140.

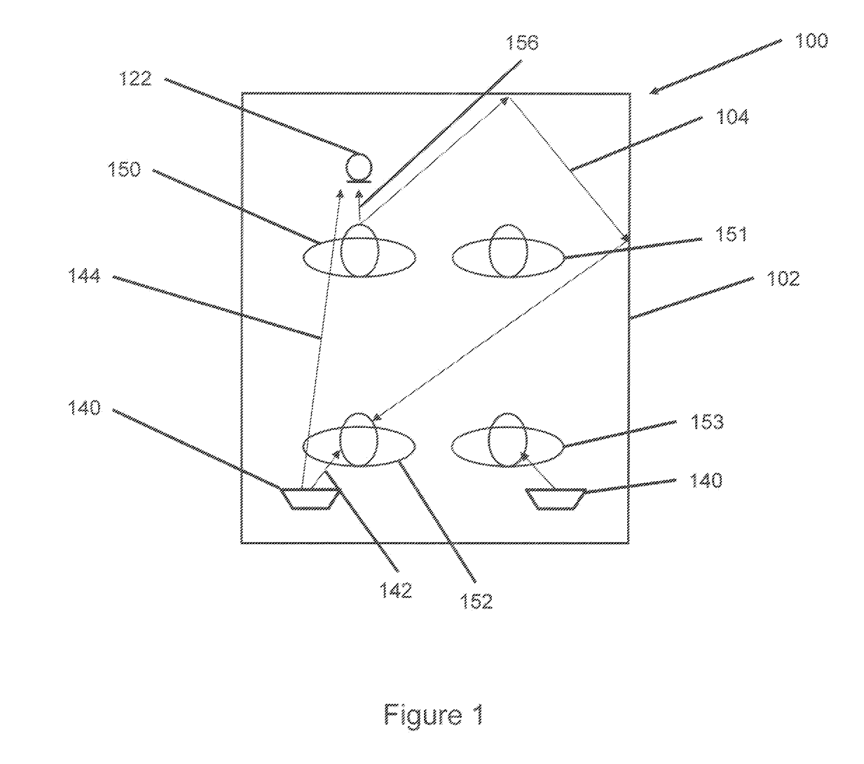

With reference FIG. 1, an exemplary vehicle 100 includes the cabin 102. The cabin 102 accommodates one or more occupants 150-153 such as a driver 150 and passengers 151-153. In one example, the driver 150 and the front seat passenger 151 are seated in a front row of the cabin 102 and rear seat passengers 152, 153 are seated in a back row of the cabin 102. One skilled in the art will appreciate that this arrangement is merely exemplary as the vehicle 100 can include any number of rows and any number of occupants arranged in those rows.

As shown by an exemplary natural acoustic path 104, when the driver 150 faces forward and speaks, the natural acoustic path 104 from the driver 150 reflects around the cabin 102 before arriving at the rear seat passenger 152. At each reflection point about the acoustic path 104, the driver's voice diminishes such that the loudness of the voice heard by the rear seat passengers 152, 153 is less than the loudness spoken by the driver 150. Accordingly, rear seat passengers 152, 153 may have a hard time hearing the driver 150 or front seat passenger 151 talking.

Most modern vehicles 100 are equipped with a microphone array 120 to pick up audible commands and communications from occupants in the cabin 102. In one example, a microphone array 120 is used to receive audible commands and communications from the driver 150. In one example, the microphone array 120 receives audible commands to enable the driver 150 to communicate with one or more vehicle systems, such as telecommunications systems, infotainment systems, etc. over a vehicle communication bus. The audible commands may be distributed with the vehicle systems over the communication bus or further processed to reduce echo, remove ambient noise, etc. as is known to those skilled in the art.

Vehicles also generally also include at least one loudspeaker 140 arranged within the cabin 102. The loudspeaker 140 is in communication with vehicle systems over the communication bus and is used to broadcast amplified audio signals 142 from the vehicle systems (not shown). For example, the loudspeakers 140 may be used to play music or broadcast a phone conversation during hands-free calling.

With reference now to FIG. 2, an embodiment of the communication system 110 is provided. A vehicle 100 includes a cabin 102 and a plurality of occupants 150-153 seated within the cabin 102. The driver 150 and the front seat passenger 151 are seated in a front row of the cabin 102 and rear seat passengers 152, 153 are seated in a back row of the cabin 102. One skilled in the art will appreciate that this arrangement is merely exemplary as the vehicle 100 can include any number of rows and any number of occupants arranged in those rows.

The communication system 110 includes an electronic control unit 112, a microphone array 120, a beam forming module 130, and a loudspeaker 140. While the components of the communication system 110 are depicted in communication through a direct connection for simplicity, one skilled in the art will appreciate that the communication system 110 may be implemented over a vehicle communication bus such as a CAN bus, FlexRay, A2B bus or other known communication busses.

The electronic control unit 112 transmits and receives data within the communication system 110 and has a processor module 114 and a memory 116. The processor module 114 performs computing operations and accesses electronic data stored in the memory 116.

The microphone array 120 includes at least two microphones 122 and receives audible communications from within the cabin 102 and generates a microphone signal therefrom. In a preferred embodiment of the communication system 110, the microphones 122 in the microphone array 120 are arranged proximate to one another in the cabin 102. One skilled in the art will appreciate that the microphones in the microphone array 120 form a phased sensor array and therefore should be located reasonably close to one another. The exact arrangement of the microphones in the array should be such so as to form a microphone array 120 as opposed to two remote microphones.

Adaptive beam forming or spatial filtering is a technique that uses sensor arrays to provide directional signal transmission or reception. By making use of a phased array, signals at particular angles experience constructive interference while signal at other angles experience destructive interference. In this way, beam forming provides a method for constructing a spatial filter to selectively increasing the amplitude of signals received at some angles while simultaneously reducing the amplitude of signals received at other angles.

The beam forming module 130 of this embodiment is an adaptive or phased array digital beam former. The beam forming module 130 forms a main beam 134 directed at the source location and a null beam 136 directed at the output location. The source location and the output location are dynamically identified (i.e., identified over a time interval) by the adaptive or phased array digital beam former 130.

The beam former 130 in conjunction with the microphone array 120 identifies the source location and the output location For example, the microphone array 120 can be used to identify the source location and the output location using the time difference of direction of arrival (DOA) method. With a microphone array 120 having at least two microphones 122, the source location and the output location can be identified using the cross correlation function between the signals received by each microphone 122 of the microphone array 120. One skilled in the art will appreciate that various techniques may be employed using the microphone array 120 and beam former 130 to identify the source location and the output location including the inter-aural time difference and triangulation.

The source location and the output location may also be identified by the beam former 130 by maximizing the output energy of the beam former output signal 138 as is known to those skilled in the art. The beam former 130 may further make use of algorithms such as the Linear Constrained Maximum Variance (LCMV) algorithm to estimate the source location and the output location. In another embodiment, at least one of the source location and the output location is predetermined and the remaining location is estimated by the beam former 130. In another embodiment, a vehicle sensor (not shown) such as a seat sensor provides information relating to the location of the front seat occupants 150, 151 to the communication system 110. For example, a seat sensor may be used to determine if a front seat passenger 151 is in the cabin 102. The sensor may also provide information relating to the location of the driver 150 on the seat.

Adaptive beam forming is achieved by filtering and processing the microphone signal from the microphone array 120 and combining the beam forming outputs. Once the source location and the output location are known, the beam forming module 130 can be used to extract the desired signal and reject interfering signals according to their spatial location. In this way, the communication system 110 processes signals received by the microphone array 120 to extract desired communications such as the driver's 150 voice while rejecting unwanted signals such as acoustic feedback from the loudspeaker 140.

In an embodiment there is one beam forming module 130 for each occupant, or source location, in the cabin 102. For example, throughout the Figures two occupants 150, 151 are shown in the front row of the cabin 102. Accordingly, the communication system 110 according to this embodiment has two beam forming modules 131, 132, one for each front row occupant that would have their voice broadcast over the communication system 110. The outputs from the beam forming modules 131, 132 are combined to generate the beam former output signal 138. One skilled in the art will appreciate that it is desirable to have a beam forming module 130 for each source location and, as such, additional beam forming modules 130 may be used to provide for isolated signal amplification at additional source locations relative to the exemplary embodiments.

The loudspeaker 140 is used to broadcast the beam former output signal 138 from the communication system 110 and other vehicle systems (not shown). While the Figures depict a single loudspeaker 140 for simplicity, in additional embodiments multiple loudspeakers 140 are arranged about the cabin. One skilled in the art will appreciate that it is desirable to have a null beam 136 for each output location. Therefore, additional null beams 136 may be used to provide for isolated signal attenuation at additional output locations relative to the exemplary embodiments.

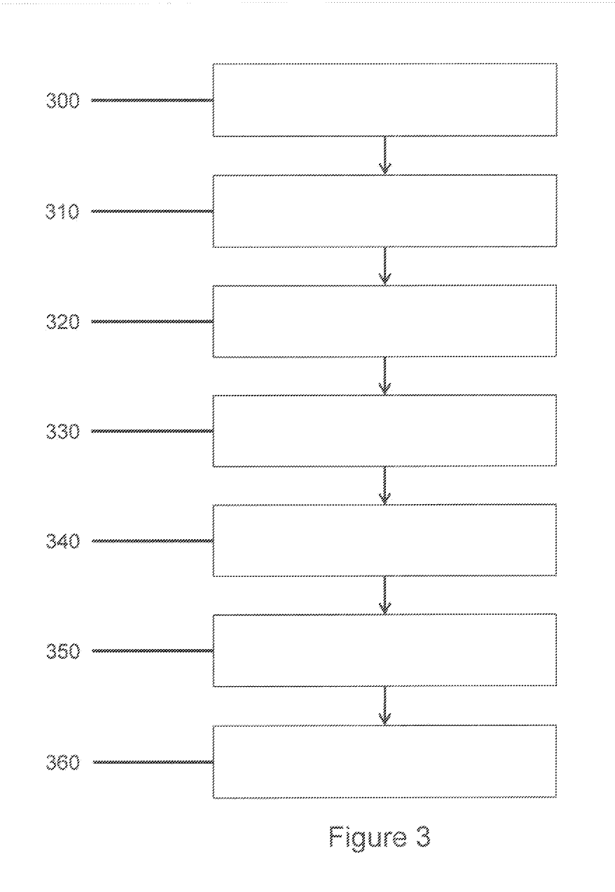

Referring now to FIG. 3, and with continued reference to FIG. 2, a flowchart illustrates a preferred method performed by the communication system 110 of FIG. 2 in accordance with the present disclosure. As can be appreciated in light of the disclosure, the order of operation within the method is not limited to the sequential execution as illustrated in FIG. 3, but may be performed in one or more varying orders as applicable and in accordance with the requirements of a given application.

In an exemplary embodiment, the communication system 110 and method are run when the communication system 110 is enabled by an occupant through a vehicle system such as a button or vehicle interface (not shown). In various embodiments, the method can be scheduled to run based on predetermined events, and/or can run continuously during operation of the vehicle 100.

At 300, the communication system 110 begins the routine. In the exemplary embodiment of FIG. 2, the driver 150 is the speaking occupant, however the front seat passenger 151 may be the speaking occupant. At 310, a main beam 134 is formed by the beam former 130 and directed at the source location. At 320, a null beam 136 is formed and directed at the output location. One skilled in the art will appreciate that the order of forming and directing the main beam 134 (310) and the null beam 136 (320) may be interchanged without departing from the spirit of the invention, so long as the beams are formed and directed at their respective locations. Additionally, as detailed above, one or both of the source location and the output location may be predetermined and stored in memory 116 to be used by the beam former 130 at 310 and 320.

At 330, an audible communication from the speaking occupant is received by the microphones 122 of the microphone array 120 to generate a microphone signal 137. At 340, the electronic control unit 112 filters and processes the microphone signal 137 using a spatial filter from the beam forming module 130 as a function of the main beam 134 and the null beam 136 to generate an beam former output signal 138. At 350, beam former output signal 138 is broadcasted over the loudspeaker 140 in the cabin 102 as the broadcasted communication 142. At 360, the routine ends and restarts operation for as long as the communication system 110 is active.

One skilled in the art will appreciate that at 340 additional filtering and processing may occur to improve the quality of the beam former output signal 138. For example, noise reduction, echo cancellation, and dynamic amplification based on noise in the cabin 102 may also be performed.

In this way, the communication system 110 uses the microphone array 120, the electronic control unit 112 and the beam forming module 130 to spatially filter signals that are subsequently broadcast in the cabin 102. The main beam 134 directed at the source location isolates and amplifies audible communications originating at the source location, while a null beam 136 directed at an output location attenuates sounds originating at the output location. In one example, the null beam 136 reduces the impact of acoustic feedback of the communication system 110.

While the method described in conjunction with FIG. 3 includes dynamically directing a main beam 134 at a source location of a speaking occupant and a null beam 136 an output location of a loudspeaker within the cabin 102 of the vehicle 100, one skilled in the art will appreciate that the location of the front seat occupants 150, 151 are generally known and located in a predetermined relationship to the microphone array 120. As such, the source location when either of the front seat occupants 150, 151 is the speaking occupant can be predetermined relative to the microphone array 120. Therefore, in one embodiment of the communication system 110, one or more main beams 134 can be directed at predetermined or statically identified source locations relative to the microphone array 120.

Furthermore, loudspeakers 140 within the cabin 102 of the vehicle 100 are also often predetermined relative to the microphone array 120. As such, in one embodiment, one or more null beams 136 can be directed at predetermined or statically identified output locations relative to the microphone array 120.

Accordingly, in one embodiment the communication system 110 can operate under the assumption that the one or more source locations and one or more output locations are predetermined relative to the microphone array 120. The predetermined source locations and predetermined output locations can be preloaded and stored in the memory 116 of the electronic control unit 112 by the manufacturer, determined in an initial calibration and stored in the memory 116, or otherwise stored in the memory 116 so that the communication system 110 need not dynamically identify the source location and output location while the communication system 110 is operating.

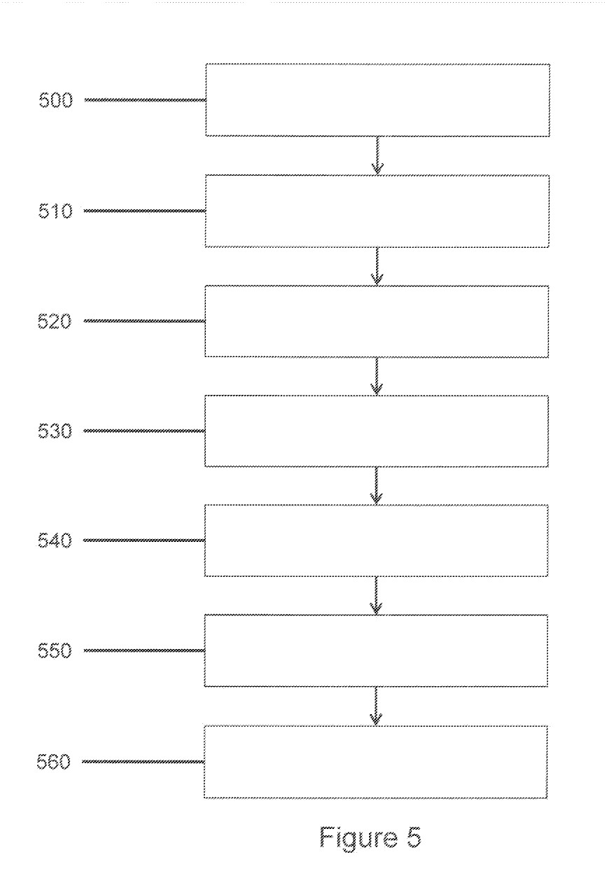

With reference now to FIGS. 4 and 5, another embodiment of the communication system 110 is provided. In this embodiment, the communication system 110 addresses the situation where one or both of the front seat occupants 150, 151 are speaking The digital beam former 130 includes two digital beam former modules 131, 132 to form a first main beam 134 and a second main beam 135 directed at the driver 150 and front seat passenger, respectively. As detailed above, the source locations of the speaking occupants 150, 151 may be dynamically identified as in the previous embodiment for use throughout the present embodiment. The source location and the output location may also be predetermined and stored in a memory 116, dynamically estimated by the digital beam former 130, or otherwise identified as previously described.

Referring now to FIG. 5, and with continued reference to FIG. 4, a flowchart illustrates a control method that can be performed by the communication system 110 of FIG. 4 in accordance with the present disclosure. As can be appreciated in light of the disclosure, the order of operation within the method is not limited to the sequential execution as illustrated in FIG. 5, but may be performed in one or more varying orders as applicable and in accordance with the present invention.

At 500, the communication system 110 begins the routine. At 510, at least one main beam 134, 135 is directed at the front seat occupants 150, 151 relative to the microphone array 120. In one example, a first main beam 134 is formed by the first beam former module 131 and directed at the driver 150. A second main beam 135 is formed by the second beam former module 132 and directed at the front seat passenger 151. At 520, a null beam 136 is directed at the output location, which is the loudspeaker 140. At 530, the audible communication is received by the microphone array 120 and a microphone signal 137 is generated. At 540 the electronic control unit 112 filters and processes the microphone signal 137 using a spatial filter from the beam forming module 130 as a function of the main beams 134, 135 and the null beam 136 to generate a beam former output signal 138.

As there are two main beams 134, 135, the beam former output signal 138 can be generated by summing the partial beam former output signals from the first and second beam forming modules 131, 132, averaging the partial output signals together, or otherwise processing the partial beam output signals with the electronic control unit 112 in conjunction with one another. At 550 the beam former output signal 138 generated by the communication system 110 is broadcast over the loudspeaker 140 in the cabin 102 as the broadcasted communication 142. At 560, the routine ends and restarts operation for as long as the communication system 110 is active.

As detailed above, one skilled in the art will appreciate that at 540 additional filtering and processing may occur to improve the quality of the beam former output signal 138. For example, noise reduction, echo cancellation, and dynamic amplification based on noise in the cabin 102 may also be performed.

In one embodiment, when the main beams 134, 135 are directed at predetermined locations, at 540 the communication system 110 can select one or more main beams 134, 135 with the electronic control unit 112 and exclude other main beams from the spatial filter to target a specific speaking occupant. For example by way of FIG. 4, if the communication system 110 determines that front seat passenger 151 is the speaking occupant, then the spatial filter can make use of the main beam 135 directed at the speaking occupant, namely the front seat passenger 151. As such, the spatial filter does not unnecessarily amplify audible communications originating at other source locations, i.e. source locations that do not correspond to the speaking occupant.

While various exemplary embodiments have been presented in the foregoing detailed description, it should be appreciated that a vast number of variations exist. It should also be appreciated that the exemplary embodiments are only examples, and are not intended to limit the scope, applicability, or configuration of the disclosure in any way. Rather, the foregoing detailed description will provide those skilled in the art with a convenient road map for implementing the exemplary embodiments. It should be understood that various changes can be made in the function and arrangement of elements without departing from the scope of the disclosure as set forth in the appended claims and the legal equivalents thereof.

What is claimed is:

1. A method for improving communication between occupants in a cabin, comprising:
forming a main beam directed at a source location using a beam forming module;
forming a null beam directed at an output location using the beam forming module;
receiving an audible communication from a speaking occupant with at least one microphone in a microphone array and generating a microphone signal;
filtering the microphone signal using a spatial filter based on the main beam and the null beam to generate a beam former output signal; and
broadcasting the beam former output signal over the loudspeaker.

2. The method of claim 1, further comprising:
identifying the source location of the speaking occupant using the microphone array including at least two microphones.

3. The method of claim 1, further comprising:
directing the main beam at a predetermined location, the predetermined location stored in a memory and corresponding to the source location relative to the microphone array.

4. The method of claim 1, further comprising:
forming a first main beam directed at a first source location using a first beam forming module;
forming a second main beam directed at a second source location using a second beam forming module; and
broadcasting the sum of the first and second beam former output signals over the loudspeaker.

5. The method of claim 1, further comprising:
filtering the microphone signal by selecting the main beam based on which of the occupants is identified as the speaking occupant.

6. The method of claim 1, further comprising:
directing at least one null beam at each of a plurality of output locations.

7. A system for improving communication between occupants in a cabin, comprising:
an electronic control module having a processor and a memory;
a microphone array configured to receive an audible communication from a speaking occupant and generate a microphone signal in response thereto;
a loudspeaker having an output location, and the loudspeaker configured to broadcast a beam former output signal;
a beam forming module configured to form a main beam directed at a source location and a null beam directed at the output location; and
a spatial filter configured to filter the microphone signal based on the main beam and the null beam, and to generate the beam former output signal based on the microphone signal.

8. The system of claim 7, wherein the microphone array comprises at least two microphones.

9. The system of claim 7, wherein the source location is defined in the memory as a predetermined location relative to the microphone array, wherein the main beam is directed at the predetermined location.

10. The system of claim 7, further comprising:
a plurality of beam forming modules each configured to form a main beam directed at one of a plurality of source locations and a null beam directed at the output location, each beam forming module generating a partial beam former output signal, and
wherein the beam former output signal is the summation of each of the partial beam former output signals.

11. The system of claim 7, wherein a plurality of source locations are defined in the memory as predetermined locations relative to the microphone array, wherein the main beam is directed at one of the predetermined locations based on the source location of the speaking occupant.

12. The system of claim 7, wherein at least one null beam is directed at each of a plurality of output locations.

13. The system of claim 7, further comprising:
a sensor configured to identify the source location of the speaking occupant.

14. A vehicle, comprising:
a cabin; and
a system for improving communication between occupants in the cabin, the system including:
an electronic control module having a processor and a memory;
a microphone array for receiving an audible communication from a speaking occupant and generating a microphone signal in response thereto;
a loudspeaker having an output location, the loudspeaker configured to broadcast a beam former output signal;
a beam forming module forming a main beam directed at a source location and a null beam directed at the output location; and
a spatial filter configured to filter the microphone signal based on the main beam and the null beam and to generate the beam former output signal based on the microphone signal.

15. The vehicle of claim 14, wherein the microphone array comprises at least two microphones.

16. The vehicle of claim 14, wherein the source location is defined in the memory as a predetermined location relative to the microphone array, wherein the main beam is directed at the predetermined location.

17. The vehicle of claim 14, further comprising:
a plurality of beam forming modules each configured to form a main beam directed at one of a plurality of source locations and a null beam directed at the output location, each beam forming module generating a partial beam former output signal, and
wherein the beam former output signal is the summation of each of the partial beam former output signals.

18. The vehicle of claim 14, wherein a plurality of source locations are defined in the memory as predetermined locations relative to the microphone array, and wherein the main beam is directed at one of the predetermined locations based on the source location of the speaking occupant.

19. The vehicle of claim 14, wherein at least one null beam is directed at each of a plurality of output locations.

20. The vehicle of claim 14, further comprising:
a sensor configured to identify the source location of the speaking occupant.
